(19) United States
(12) Patent Application Publication
(10) Pub. No.: US 2007/0258589 A1
(43) Pub. Date: Nov. 8, 2007

(54) Digital television receiver and method for processing a digital television signal

(75) Inventor: In Moon Kim, Gyeonggi-do (KR)

Correspondence Address: MCKENNA LONG & ALDRIDGE LLP, 1900 K STREET, NW, WASHINGTON, DC, 20006, US

(73) Assignee: LG. Electronics, Inc., Seoul (KR)

(21) Appl. No.: 11/790,889

(22) Filed: Apr. 27, 2007

(30) Foreign Application Priority Data
Apr. 28, 2006 (KR) 10-2006-0039044

(51) Int. Cl. H04N 7/167

(52) U.S. Cl. 380/204

(57) ABSTRACT

A method of processing a digital television signal in a digital television receiver, the method includes receiving a digital television signal including blocks of content and a conditional access table including conditional access management information; parsing the conditional access table, the parsed conditional access table including copy control information specifying content copy permission; and determining whether to permit generation of a copy of the content according to the copy control information.

This application claims the benefit of Korean Patent Application No. 10-2006-0039044, filed on Apr. 28, 2006, which is hereby incorporated by reference as if fully set forth herein.

### BACKGROUND OF THE INVENTION

1. Field of the Disclosure

The present disclosure relates to a digital television (DTV) receiver and a method for processing a DTV signal.

2. Background

Now, transition to digital terrestrial broadcasting is accelerating. Accordingly, a broadcasting station for transmitting a terrestrial broadcasting signal must provide a service for transmitting high-quality contents in order to ensure viewers.

The broadcasting station must protect the transmitted high-quality content to protect the copyright on the content transmitted from the broadcasting station in the transmission of the high-quality contents. As digital terrestrial television receivers and AV devices come into wide use, the high-quality content transmitted from the broadcasting station may be illegally copied. Accordingly, the content cannot be appropriately protected.

A content provider may lose a desire for creating contents due to illegal copying, and thus an economical loss may occur. Rights to the copying of contents needs to be applied to all AV devices for receiving a terrestrial broadcasting signal.

### SUMMARY

Accordingly, the present disclosure is directed to a digital television (DTV) receiver and a method for processing a DTV signal that substantially obviate one or more problems described above.

For example, the disclosure may disclose a DTV receiver and a method for processing a DTV signal, by which copy control information may be generated a copy of the content.

Advantages, objects, and features of the invention in part may become apparent in the description which follows and in part may become apparent to those having ordinary skill in the art upon examination of the following or may be learned from practice of the invention. The objectives and other advantages of the various embodiments of the invention may be realized and attained by the structures and processes described in the written description, in the claims, and in the appended drawings.

To achieve these objects and other advantages and in accordance with the purpose of the invention, as embodied and broadly described herein, a method includes receiving a digital television signal including blocks of content and a conditional access table including conditional access management information; parsing the conditional access table, the parsed conditional access table including copy control information specifying content copy permission; and determining whether to permit generation of a copy of the content according to the copy control information.

In another aspect, a digital television receiver includes a tuner arranged to receive a digital television signal including blocks of content; a demodulator arranged to demodulate the digital television signal the conditional access table including; a demultiplexer arranged to demultiplex a conditional access table from the demodulated digital television signal; a decoder arranged to parse the conditional access table, the parsed conditional access table including copy control information specifying content copy permission; and a controller arranged to determine whether to permit generation of a copy of the content according to the copy control information.

It is to be understood that both the foregoing general description and the following detailed description are exemplary and explanatory and should not be construed as limiting the scope of the claims.

### BRIEF DESCRIPTION OF THE DRAWINGS

The accompanying drawings, which are included to provide a further understanding of the disclosure are incorporated in and constitute a part of this application. The drawings together with the description serve to explain the principle of the invention. In the drawings:

FIG. 1 is an exemplary diagram of bit stream syntax for conditional access (CA) section;

FIG. 2 is an exemplary diagram of a conditional access (CA) descriptor;

FIG. 3 is a block diagram of an exemplary digital television receiver; and

FIG. 4 is an exemplary flowchart of a method for processing a digital television signal including copy control information.

### DETAILED DESCRIPTION

Reference will now be made in detail to a digital television (DTV) receiver and a method for processing the DTV signal according to the various embodiments, examples of which are illustrated in the accompanying drawings. Wherever possible, the same reference numbers will be used throughout the drawings to refer to the same or like parts for simplicity. In addition, although the terms used in the present invention are selected from generally known and used terms, some of the terms mentioned in the description of the present disclosure have been selected by the applicant at his or her discretion, the detailed meanings of which are described in relevant parts of the description herein. Furthermore, it is required that the present disclosure is understood, not simply by the actual terms used but by the meanings of each term lying within.

Hereinafter, a DTV signal comprising copy control information and a method and apparatus for processing the DTV signal will be described in detail with reference to the accompanying drawings.

The term “copy control information” used herein specifies content copy permission. A DTV receiver may generate a copy of the content in the DTV receiver or an external device according to the copy control information.

Accordingly, in a case where a transmitter provides high-quality contents and a receiver implements the high-quality contents, the copy of the content may be permitted in order to protect the content.

The DTV signal including the copy control information for protecting contents may be transmitted by a moving picture experts group-2 (MPEG-2) system. For example, the copy control information may be included in program specific information (PSI) for providing information on a parameter and a packet identifier (PID) of a transport stream (TS) packet included in the MPEG-2 system.

The PSI is carried in the TS and may include normative data and private data for allowing programs to be demultiplexed by decoders. In the TS, the PSI includes a program association table (PAT) for providing the correspondence between the PID values of TS packets for carrying a program number and a program definition, a program map table (PMT) for providing program numbers and mappings between elementary streams for configuring the program numbers, a conditional access table (CAT) related to at least one (private) entitlement management message (EMM) having a unique PID value, and a network information table (NIT) structure for specifying physical network parameters such as transponder numbers for automatically transmitting a response when receiving a frequency division multiplex (FDM) signal.

The copy control information is included in the CAT among the plurality of tables contained in the PSI. Hereinafter, for example, a case where the copy control information is contained in a conditional access (CA) descriptor among the descriptors of the CAT will be described. At this time, the table which includes the copy control information for protecting the contents is not limited to the CAT and other tables may be used.

The information for protecting the contents may be contained in a new table of the DTV signal, instead of in the existing table such as the CAT. The information for protecting the contents may be included in a new descriptor instead of in the CA descriptor. Alternatively, a reserved field of the CAT may be used.

The CAT provides association between one or more CA systems, their EMM streams and any special parameters associated with them. The table may be segmented into one or more sections, before insertion into TS packets, with the following syntax.

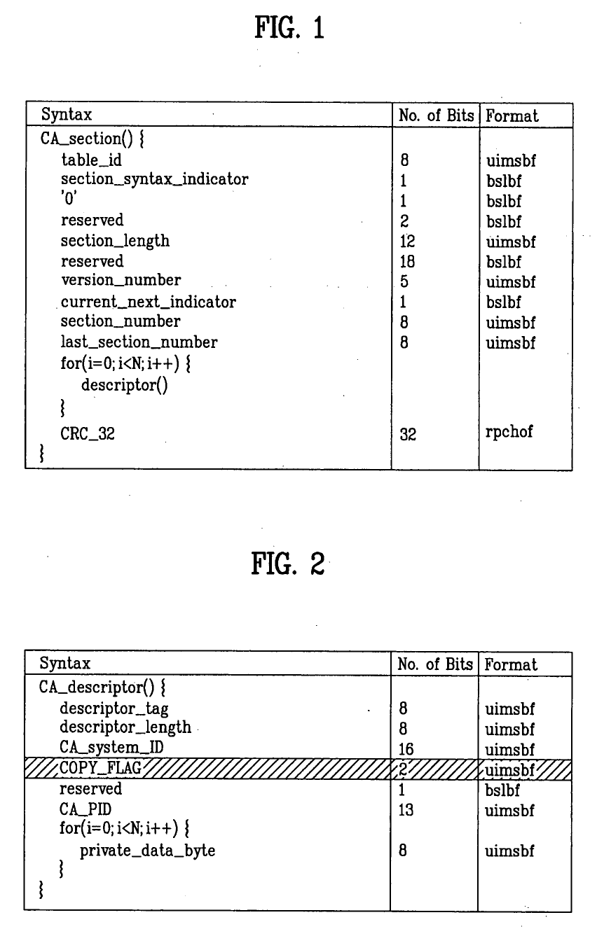

FIG. 1 is an exemplary diagram of bit stream syntax for CA section. Hereinafter, the CAT containing the copy control information will be described. For convenience of description, the fields of the syntax are marked by bold letters.

A table_id is an 8-bit field, which should be always set to 0x01. A section_syntax_indicator is a 1-bit field which should be set to ‘1’. A section_length is a 12-bit field, the first two bits of which should be ‘00’. It specifies the number of bytes of the section starting immediately following the section_length field, and including the cyclic redundancy check (CRC).

A version_number is 5-bit field, the version number of the whole CAT. The version number should be incremented by 1 when a change in the information carried within the CAT occurs. When it reaches the value 31, it wraps around to 0. When the current_next_indicator is set to ‘1’, then the version_number should be that of the currently applicable CAT. When the current_next_indicator is set to ‘0’, then the version_number should be that of the next applicable CAT.

A current_next_indicator field is a 1-bit indicator, which when set to ‘1’ indicates that the CAT sent is currently applicable. When the bit is set to ‘0’, it indicates that the CAT sent is not yet applicable and should be the next CAT to become valid.

A section_number is an 8-bit field gives the number of this section. The section_number of the first section in the CAT should be ‘0x00’. It should be incremented by 1 with each additional section in the CAT. A last_section_number is an 8-bit field specifies the number of the last section (that is, the section with the highest section_number) of the CAT. A CRC_32 is a 32-bit field that contains the CRC value that gives a zero output of the registers in the decoder after processing the entire CAT section.

The programs and the elementary stream descriptors in the PSI are used to extend the definition for the programs and the elementary streams. At this time, all the stream descriptors may have a format starting with an 8-bit tag value and the tag value is followed by an 8-bit descriptor length and data fields.

In the present disclosure, the CA descriptor is used to specify the system-wide CA management information such as EMMs and elementary stream-specific information such as entitlement control messages (ECMs).

If any elementary stream is scrambled, the CA descriptor must be present for the program containing that elementary stream. If any system-wide CA management information exists within TS, the CA descriptor must be present in the appropriate map section. The content of the TS packets including conditional access information are private.

The CA descriptor is used to specify both system-wide conditional access management information such as EMMs and elementary stream-specific information such as ECMS. It may be used in both the TS_program_map_section and the program_stream_map. If any elementary stream is scrambled, a CA descriptor must be present for the program containing that elementary stream. If any system-wide conditional access management information exists within TS, a CA descriptor must be present in the appropriate map section.

When the CA descriptor is found in the TS_program_map_section (table_id=0x02), the CA_PID points to packets containing program related access control information, such as ECMS. Its presence as extended program information indicates applicability to the entire program. In the same case, its presence as extended ES information indicates applicability to the associated elementary stream. Provision is also made for private data.

When the CA descriptor is found in the CA_section (table_id=0x01), the CA_PID points to packets containing system-wide and/or access control management information, such as EMMs.

The contents of the TS packets containing conditional access information are private.

FIG. 2 is an exemplary diagram of a conditional access (CA) descriptor. Hereinafter, the fields of the CA descriptor including the copy control information for protecting the contents according to the present disclosure will be described.

A CA_system_ID is a 16-bit field indicating the type of CA system applicable for either the associated ECM and/or EMM streams. That is, it is information for notifying through which broadcasting system (broadcasting apparatus) the transmitter transmits the CA data.

A CA_PID is a 13-bit field indicating the PID of the TS packets which should contain either ECM or EMM information for the CA systems as specified with the associated CA_system_ID. The contents (ECM or EMM) of the packets indicated by the CA_PID are determined from the context in which the CA_PID is found, i.e. the PMT or the CAT in the TS or the stream_id field in the Program Stream.

A COPY_FLAG is a 2-bit field identifying the copy control information specifying content copy permission. The definition of the field values may be, for example, shown in Table 1. By this definition, the receiver controls the copying of the contents.

TABLE 1

| | Digital Copy |
|---|---|
| COPY_FLAG | Permission |
| 00 | Copying not |
| | restricted |
| 01 | No further |
| | copying is permitted |
| 10 | One generation |
| | copy is permitted |
| 11 | Copying is |
| | prohibited |

If the value of the COPY_FLAG field is ‘00’, copying of the content is not restricted. That is, copying of the content is permitted without restricting the number of times. Accordingly, the DTV receiver can generate a copy of the content in the DTV receiver or an external device regardless of the number of times.

If the value of the COPY_FLAG field is ‘11’, copying is prohibited. That is, copying of the content is restricted from the beginning. Accordingly, the DTV receiver cannot generate a copy of the content in the DTV receiver or the external device from the beginning. For example, even one generation copy of the content cannot be permitted.

For example, it is possible to restrict the storage of the content in an external storage or a digital video recorder (DVR) for converting an analog video signal into a digital signal, and compressing and storing the digital signal so as to copy the content in the DTV receiver.

If the value of the COPY_FLAG field is ‘01’, no further copying of the content is permitted. It is associated with a case where the value of the COPY_FLAG field is ‘10’. If the value of the COPY_FLAG field is ‘10’, specific generation copy of the content is permitted. The specific generation is at least one. For example, Table 1 shows a case where the specific generation is set to one. Accordingly, the DTV receiver can generates specific generation copy of the content in the DTV receiver or the external device. Therefore, in Table 1, if the value of the COPY_FLAG field is ‘10’, the DTV receiver can generate specific generation copy of the content to the DVR or the external device. When the contents are copied specific generation, the value of the COPY_FLAG field must be changed such that no further copying of the content is permitted. At this time, the value of the COPY_FLAG field is changed from ‘10’, that is, ‘One generation copy of the content is permitted’ to ‘01’, that is, ‘No further copying of the content’ such that the DTV receiver can generate no further copying the content. As described above, it can be seen that the case where the value of the COPY_FLAG field is ‘01’ results from the case where the value of the COPY_FLAG field is ‘10’.

The case where the value of the COPY_FLAG field is ‘01’ and the case where the value of the COPY_FLAG field is ‘11’ are similar to each other in that the copying of the content is restricted. However, while copying is restricted from the beginning and thus the copying of the original contents is impossible if the value of the COPY_FLAG field is 11′, the contents are copied by the specific generation and the copied contents are then no more copied if the value of the COPY_FLAG field is ‘01’.

Accordingly, the case where the value of the COPY_FLAG field is ‘01’ and the case where the value of the COPY_FLAG field is ‘11’ are similar to each other in that copying is impossible. However, it can be seen that the COPY_FLAG field having the value of ‘01’ indicates that the contents to be copied are contents copied once, not original contents. Therefore, the case where the value of the COPY_FLAG field is ‘01’ and the case where the value of the COPY_FLAG field is ‘11’ are different from each other in their meanings.

In Table 1, the copy control information specifying content copy permission was defined using 2 bits. This is a preferred example of the present disclosure and the present disclosure is not limited to the above-described example. Accordingly the copy control information may be defined using a larger number of bits. In Table 1, the name of the COPY_FLAG field, the values of the COPY_FLAG field, and the definition of the values are only an example and the present disclosure is not limited to the above-described example.

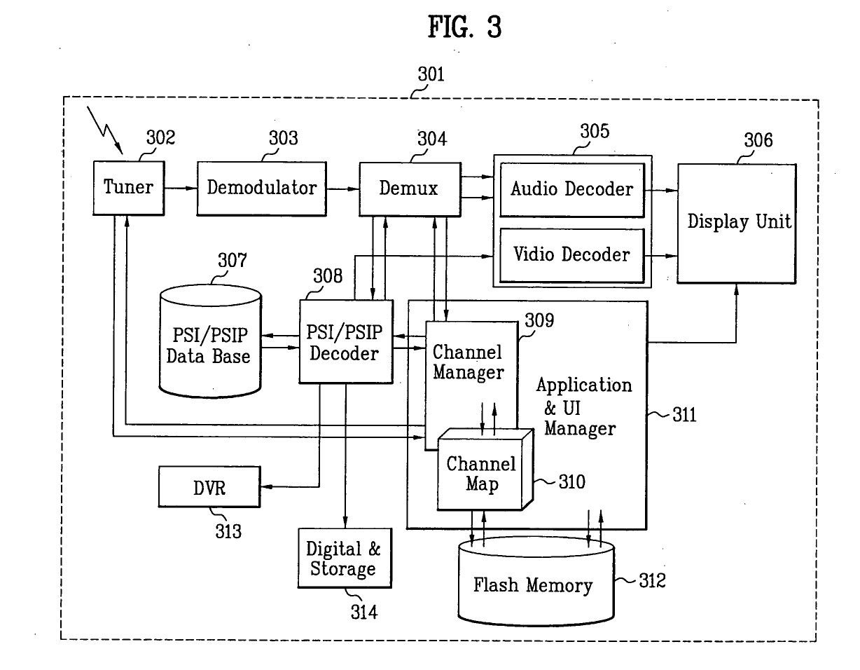

FIG. 3 is a block diagram of an exemplary digital television (DTV) receiver for processing a DTV signal including copy control information. Hereinafter, the configuration of the DTV receiver for processing the DTV signal including copy control information will be described with reference to FIG. 3.

The DTV receiver 301 according to the present disclosure includes a tuner 302, a demodulator 303, a demultiplexer 304, an audio/video (A/V) decoder 305, a display unit 306, a program specific information/program and system information protocol (PSI/PSIP) database 307, a PSI/PSIP decoder 308, a channel manager 309, an application and user interface (UI) manager 311, a flash memory 312, a digital video recorder (DVR) 313, and a digital output and storage 314.

The tuner 302 receives and tunes a DTV signal. The tuned DTV signal includes blocks of content and a conditional access table (CAT) comprising copy control information specifying content copy permission. The operation of the tuner 302 is controlled by the channel manager 309 such that the result of the received DTV signal is recorded in the channel manager 309.

The demodulator 303 receives and demodulates the tuned signal into a vestigial side band/enhanced vestigial side band (VSB/EVSB) signal.

The demultiplexer 304 demultiplexes demodulated transport stream (TS) into audio, video, and program specific information/program and system information protocol (PSI/PSIP) table. At this time, the demultiplexing of the audio and video information is controlled by the channel manager 309. When the PSI/PSIP decoder 308 sets an A/V PID of a corresponding virtual channel as a condition, the demultiplexer 304 demultiplexes an A/V elementary stream (ES) and transmits the demultiplexed A/V ES to the A/V decoder 305. The demultiplexing of the PSI/PSIP table is controlled by the PSI/PSIP decoder 308. The demultiplexer 504 filters PSI/PSIP table sections and transmits the sections to the PSI/PSIP decoder 308.

The PSI/PSIP decoder 308 parses the filtered PSI/PSIP table sections and reads and records all actual section data in the PSI/PSIP database 307.

The channel manager 309 may request the reception of a channel-related information table by referring to the channel map 310 and receive the result. At this time, the PSI/PSIP decoder 308 controls the demultiplexing of the channel-related information table and transmits a list of A/V PIDs to the channel manager 309. The channel manager 309 may directly control the demultiplexer 304 using the received A/V PIDs to control the A/V decoder 305.

The application and UI manager 311 controls a graphical user interface (GUI) for displaying the state of the receiver with an on-screen display (OSD).

In particular, when the PSI/PSIP decoder 308 sets the PID of conditional access (CA) section including the copy control information as a condition, the demultiplexer 304 filters only the CA section among a plurality of PSI/PSIP tables in the received DTV signal and transmits the CA section to the PSI/PSIP decoder 308.

The PSI/PSIP decoder 308 receives and parses the filtered CAT. At this time, since the copy control information is contained in the CA descriptor of the CAT, the CA descriptor is also parsed. The PSI/PSIP decoder 308 stores the copy control information included in the parsed CA descriptor in the PSI/PSIP database 307.

Accordingly, the transmitter/receiver can selectively protect the content by using the copy control information stored in the PSI/PSIP database 307. That is, the DTV receiver can copy and store the received content in the DVR 313 or the digital output and storage 314. At this time, the DTV receiver can control the content copy permission to protect the content according to the request of the user.

At this time, since the stored copy control information is any one of information indicating that copying of the content is not restricted, information indicating that no further copying of the content is permitted, information indicating that specific (e.g. one) generation copy of the content is permitted, and information indicating that copying is prohibited, it is possible to more efficiently protect the contents using the above-described information. At this time, if the copy control information is the information indicating that specific generation copy is permitted, the DTV receiver may further comprise a counter for controlling the number of copying. That is, since the DTV receiver must restrict the copying of the content after the DTV receiver is copied the content as the specific generation, the counter is used to count whether the content are copied by the specific generation.

The digital output and storage 314 may, for example, use 1394.

When it is determined that the version number is not changed from a result of parsing the CAT related to the content, the PSI/PSIP decoder 308 may not parse the CA descriptor. When the copy control information in the CA descriptor is changed, the version number of the CA section including the CA descriptor is changed. Accordingly, if the version number is not changed, it is determined that the copy control information is not changed. Thus, the CA section may be discarded.

The display unit 306 appropriately controls and displays the copy control information for protecting the contents stored in the PSI/PSIP database 307 under the control of the application and UI manager 311.

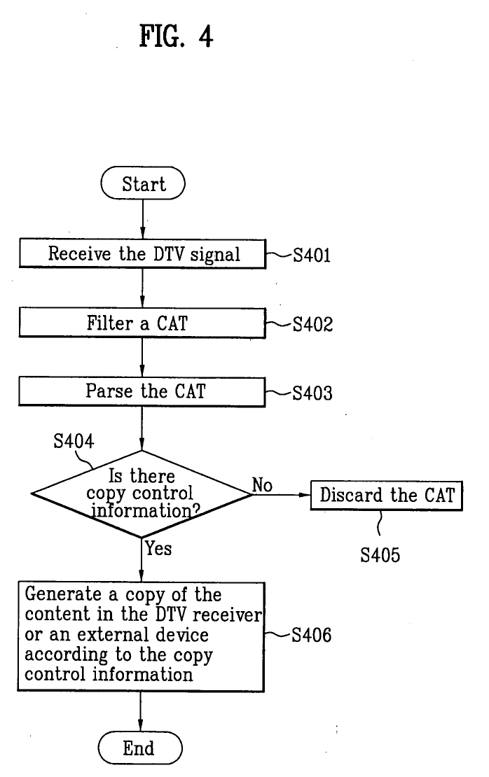

Hereinafter, a method for processing a digital television signal containing copy control information for protecting contents in the receiver will be described. FIG. 4 is an exemplary flowchart of a method for processing a digital television signal including copy control information.

First, the digital television (DTV) receiver receives a DTV signal including copy control information specifying content copy permission (S401).

The DTV receiver demultiplexes the received DTV signal and filters a conditional access (CA) sections (S402).

The DTV receiver parses the filtered CA section (S403).

The DTV receiver determines whether copy control information in the CA sections exists (S404). The DTV receiver discards the CA sections if the copy control information is not exist (S405).

The DTV receiver generates a copy of content in the receiver or an external device according to the parsed copy control information (S406).

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of processing a digital television signal in a digital television receiver, the method comprising:
receiving a digital television signal including blocks of content and a conditional access table including conditional access management information;
parsing the conditional access table, the parsed conditional access table including copy control information specifying content copy permission; and
determining whether to permit generation of a copy of the content according to the copy control information.

2. The method of claim 1, wherein the copy control information indicates a level of copy protection required.

3. The method of claim 1, wherein the copy control information indicates whether copying of the content is not restricted.

4. The method of claim 1, wherein the copy control information indicates whether no further copying of the content is permitted.

5. The method of claim 1, wherein the copy control information indicates whether one generation copy of the content is permitted.

6. The method of claim 1, wherein the copy control information indicates whether copying is prohibited.

7. The method of claim 1 further comprising generating a copy of the content in the digital television receiver or an external device if the copy control information indicates that copying of the content is not restricted.

8. The method of claim 1 further comprising generating a copy of the content in the digital television receiver or an external device if the copy control information indicates that one generation copy of the content is permitted.

9. A digital television receiver, comprising:
a tuner arranged to receive a digital television signal including blocks of content and a conditional access table including conditional access management information;
a demodulator arranged to demodulate the digital television signal;
a demultiplexer arranged to demultiplex a conditional access table from the demodulated digital television signal;
a decoder arranged to parse the conditional access table, the parsed conditional access table including copy control information specifying content copy permission; and
a controller arranged to determine whether to permit generation of a copy of the content according to the copy control information.

10. The receiver of claim 9, wherein the controller indicates a level of copy protection required.

11. The receiver of claim 9, wherein the controller indicates whether copying of the content is not restricted.

12. The receiver of claim 9, wherein the controller indicates whether no further copying of the content is permitted.

13. The method of claim 9, wherein the controller indicates whether one generation copy of the content is permitted.

14. The receiver of claim 9, wherein the controller indicates whether copying is prohibited.

15. The receiver of claim 9, wherein the controller generates a copy of the content in the digital television receiver or an external device if the content protection information indicates that copying of the content is not restricted.

16. The receiver of claim 9, wherein the controller generates a copy of the content in the digital television receiver or an external device if the copy control information indicates that one generates copy of the content is permitted.
